(19) United States
(12) Patent Application Publication
(10) Pub. No.: US 2010/0211626 A1
(43) Pub. Date: Aug. 19, 2010

(54) Method and apparatus for maintaining longer persistent connections

(75) Inventor: Rui Li, San Jose, CA (US)

Correspondence Address: SCHWABE, WILLIAMSON & WYATT P.C., 1420 5TH AVENUE, SUITE 3010, SEATTLE, WA, 98101, US

(73) Assignee: Foundry Networks, Inc., Alviso, CA (US)

(21) Appl. No.: 10/756,152

(22) Filed: Jan. 12, 2004

(51) Int. Cl. G06F 15/16

(52) U.S. Cl. 709/203; 709/227

(57) ABSTRACT

A hypertext transfer protocol (HTTP) connection between a client terminal and a server includes a client-side connection and a server-side connection. Different techniques are used to extend the persistence of the HTTP connection. These techniques include keeping the server-side connection persistent if the client terminal sends a RESET to the server, keeping the server-side connection persistent but closing the client-side connection if the client terminal sends a RESET or a FIN packet to the server, rewriting a “Connection: Close” header in a request to a “Connection: Keep-Alive,” inserting a “Connection: Keep-Alive” in a header of a request, modifying a “Connection: Close” header in a request, and changing the HTTP version value in a request.

### TECHNICAL FIELD

This disclosure relates generally to hypertext transfer protocol (HTTP) communication within a network. More particularly but not exclusively, the present disclosure relates to techniques for extending the keep-alive time of HTTP persistent connections.

### BACKGROUND INFORMATION

A typical feature of HTTP 1.1 is its support for persistent connections. Prior to persistent connections, a separate Transmission Control Protocol (TCP) connection has to be established to fetch each uniform resource locator (URL) or other resource, thereby increasing the load on HTTP servers and causing congestion on the Internet. In comparison, persistent connections allow that once a connection is opened, the connection will not be closed until consecutive operations of requests and responses are done.

The following are some advantages of persistent connections as described in Section 8.1.1 of Network Working Group, “RFC 2616 Hypertext Transfer Protocol—HTTP/1.1” (1999):
By opening and closing fewer TCP connections, central processing unit (CPU) time is saved in routers and hosts (clients, servers, proxies, gateways, tunnels, or caches), and memory used for TCP protocol control blocks can be saved in hosts.
HTTP requests and responses can be pipelined on a connection. Pipelining allows a client to make multiple requests without waiting for each response, allowing a single TCP connection to be used much more efficiently, with much lower elapsed time.
Network congestion is reduced by reducing the number of packets caused by TCP opens, and by allowing TCP sufficient time to determine the congestion state of the network.
Latency on subsequent requests is reduced since there is no time spent in TCP's connection opening handshake.
HTTP can evolve more gracefully, since errors can be reported without the penalty of closing the TCP connection. Clients using future versions of HTTP might optimistically try a new feature, but if communicating with an older server, retry with old semantics after an error is reported.

In addition, persistent connections also reduce the impact of slow-start. That is, TCP employs two congestion management mechanisms, one of which is called “slow-start,” and the other called “congestion avoidance.” Slow-start prevents overwhelming the network when a connection begins, by limiting the initial send window size and allowing that window to grow in moderation to positive feedback. Congestion avoidance incorporates the negative feedback of packet loss, and modulates the send window as a result.

Slow-start uses the first several data packets to probe the network to determine the optimal transmission rate. In slow-start, when a connection opens, only one packet is sent until an acknowledge (ACK) is received. For each received ACK, the number of packets that can be sent is increased by one. For each round-trip, the number of outstanding packets doubles, until a threshold has been reached. If a file being transferred is very small, most of that data would have already come through before the completion of the algorithm. Since most web objects are very small, HTTP 1.0 connections thus mostly use TCP at its least efficient manner. The results have been major problems due to resulting congestion and unnecessary overhead.

Persistent connection is a default behavior of HTTP 1.1. If a HTTP 1.1 client or server wants to close a persistent connection, that device needs to insert “Connection: Close” to signal the other side; then once the current transaction is done, the other side will initiate a finish (FIN) to gracefully close the TCP connection.

For HTTP 1.0, the connection is not persistent by default, and the connection will be closed once the HTTP response is successfully received by the client. A HTTP 1.0 client or server needs to explicitly tell the other that it expects the connection to be persistent by inserting a “Connection: Keep-Alive” header in its message sent to the other side.

The following sections in RFC 2616 describe the negotiation for a persistent connection between a client and a server:

8.1.2 Overall Operation
A significant difference between HTTP/1.1 and earlier versions of HTTP is that persistent connections are the default behavior of any HTTP connection. That is, unless otherwise indicated, the client should assume that the server will maintain a persistent connection, even after error responses from the server.
Persistent connections provide a mechanism by which a client and a server can signal the close of a TCP connection. This signaling takes place using the Connection header field (Section 14.10). Once a close has been signaled, the client must not send any more requests on that connection.

8.1.2.1 Negotiation
An HTTP/1.1 server may assume that a HTTP/1.1 client intends to maintain a persistent connection unless a Connection header including the connection-token “close” was sent in the request. If the server chooses to close the connection immediately after sending the response, it should send a Connection header including the connection-token close.
An HTTP/1.1 client may expect a connection to remain open, but would decide to keep it open based on whether the response from a server contains a Connection header with the connection-token close. In case the client does not want to maintain a connection for more than that request, it should send a Connection header including the connection-token close.
If either the client or the server sends the close token in the Connection header, that request becomes the last one for the connection.
Clients and servers should not assume that a persistent connection is maintained for HTTP versions less than 1.1 unless it is explicitly signaled. See Section 19.6.2 [of RFC 2616] for more information on backward compatibility with HTTP/1.0 clients.
In order to remain persistent, all messages on the connection must have a self-defined message length (i.e., one not defined by closure of the connection), as described in Section 4.4 [of RFC 2616]

Though persistent connections are advantageous, in reality it is often difficult to maintain the connection keep-alive for a sufficiently long time due to the following reasons:
Clients or servers may close a persistent connection by issuing a RESET or FIN packet too soon. For example, Microsoft Corporation's Internet Explorer™ (IE) browser will send a RESET to the server to close a persistent connection if the connection has been idle for one minute.
A client may insert a “Connection: Close” header in a request to signal the server to close the connection after the client receives the response.
A HTTP 1.0 client sending a request without “Connection: Keep-Alive” header will cause the server to close the connection after the client receives the response.

### BRIEF SUMMARY OF THE INVENTION

One aspect provides a method that defines a hypertext transfer protocol (HTTP) connection by a client-side connection and a server-side connection. The method includes establishing the HTTP connection between a client terminal and a server in response to a request from the client terminal to access the server. The method maintains persistent at least the server-side connection using a plurality of different techniques.

### BRIEF DESCRIPTION OF THE SEVERAL VIEWS OF THE DRAWINGS

Non-limiting and non-exhaustive embodiments are described with reference to the following figures, wherein like reference numerals refer to like parts throughout the various views unless otherwise specified.

FIG. 1 is a block diagram of an example system in which one embodiment may be implemented.

FIG. 2 is a flow diagram illustrating termination of a non-persistent connection.

FIG. 3 is a flow diagram illustrating a technique to maintain a persistent connection according to various embodiments.

FIG. 4 is a flow diagram illustrating a technique to maintain a persistent connection according to an embodiment.

### DETAILED DESCRIPTION

Embodiments of techniques to extend the keep-alive time of hypertext transfer protocol (HTTP) persistent connections are described herein. In the following description, numerous specific details are given to provide a thorough understanding of embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, an embodiment provides multiple techniques to maintain longer persistent connections. That is, to avoid the problems described above and to take more advantage of persistent connections (such as those provided by the default behavior of HTTP 1.1), an embodiment treats the connection between a client and a server as two connections: a client-side connection and a server-side connection. If one side wants to close the connection, the embodiment just closes one side of the connection but leaves the other side connection open (persistent). Techniques are also provided for maintaining persistent connections in situations where a HTTP 1.0 client (wherein the default behavior is not to maintain a persistent connection) communicates with a HTTP 1.1 server, or vice versa. Techniques are further provided for maintaining persistent connections in situations where a HTTP 1.0 client communicates with a HTTP 1.0 server, or vice versa.

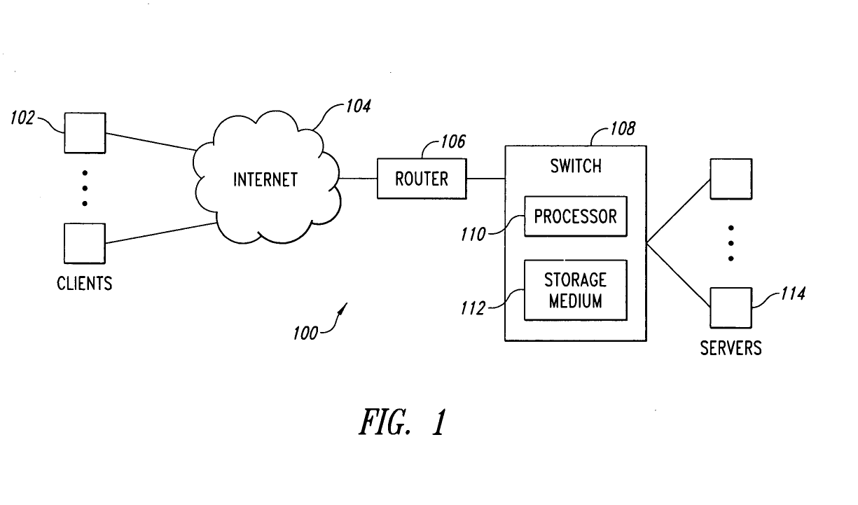

FIG. 1 is a block diagram of an example system 100 in which one embodiment may be implemented. For the sake of simplicity and brevity, not all of the possible components that may be present in the system 100 are shown in FIG. 1 or described in detail herein. Only certain components that are helpful in understanding operation of an embodiment are shown and described.

The system 100 includes a plurality of client terminals 102 (such as client terminals 100 having web browsers installed therein) that are communicatively coupled to a network 104. The network 104 is illustrated in FIG. 1 as an Internet, and it is appreciated that other embodiments can be implemented in conjunction with other types of networks, such as local area networks (LANs), virtual private networks (VPNs), and the like.

One or more routers 106 are coupled to the network 104. Each router is in turn coupled to one or more switches 108. An example of a switch 108 with which an embodiment may be implemented is the ServerIron® product available from Foundry Networks, Inc. of San Jose, Calif. The switch 108 includes one or more processors 110, and one or machine-readable storage media 112. In an embodiment, the storage medium 112 can store software, code, or other machine-readable instructions executable by the processor 110, wherein such machine-readable instructions are used in connection with maintaining persistent connections using the techniques described herein. While the switch 108 is shown and described herein for example purposes, it is appreciated that any suitable type of networking component can provide the functionality and features with regards to maintaining persistent connections. For example, the functionality and features to maintain persistent connections can be implemented in a router or a gateway device.

Each of the switches 108 is coupled to a plurality of servers 114. The servers 114 can provide access to applications, web sites, files and data, or other resources requested by the client terminals 102. A uniform resource locator (URL), destination address, port number, IP address, hostname, domain name, or other suitable identification mechanism can identify these resources and/or the servers 114.

In one embodiment, the communication between the various components in the system 100 can be performed using packet-based or packet-switching communication techniques. Example protocols are TCP/IP and HTTP, although it is appreciated that a person skilled in the art having the benefit of this disclosure can adapt other embodiments to other types of communication techniques or protocols.

According to an embodiment, the client-side connection is defined as the connection between the client 102 and the switch 108, while the server-side connection is defined as the connection between the switch 108 and the server 114. Thus, the client-side connection of FIG. 1 can include all of the connections between the various network components (e.g., components within the network 104, the router 106, and other network components not shown), which are present between the client terminal 102 and the switch 108. Similarly, the server-side connections can include any intermediate connections between network components located between the switch 108 and the server 114. It is appreciated that the switch 108 is merely being used herein as an example location where the boundary between the client-side and server-side connections are delineated—other locations may be defined or used as the boundary between the client-side connections and the server side connections, such as the router 106, a gateway device, a hub, or other network location.

According to a first embodiment (which may be used in conjunction with other embodiments), a persistent connection can be maintained if the client terminal 102 sends a RESET to the server 114. In this case, the client-side connection will be closed immediately, while the server-side connection will be de-linked from the client-side connection and will remain open if a HTTP transaction is performed subsequently by another (or the same) client terminal 102. That is, the de-linked server-side connection will remain persistent (or kept-alive by the switch 108) and can be reused by other client terminals 102 in the future. Thus, when such client terminals 102 wish to connect to the server 114, only the client-side connection need be established and the existing/persistent server-side connection can be reused.

According to a second embodiment, a persistent connection can be maintained if the client terminal 102 sends a FIN packet to the server 114. If the client terminal 102 initiates a FIN packet over a persistent connection, the client terminal 102 will perform the normal handshake of FIN termination and gracefully close the connection on the client side. The server-side connection will be de-linked from the client-side connection and remain open if a HTTP transaction is subsequently performed. Similarly in this embodiment, other client terminals 102 can reuse the server-side connection in the future. According to this embodiment, if the server 114 sends a RESET or FIN packet to the client terminal 102 over a persistent connection, the switch 108 will prioritize the communication from the server 114 and thus close both client-side and server-side connections.

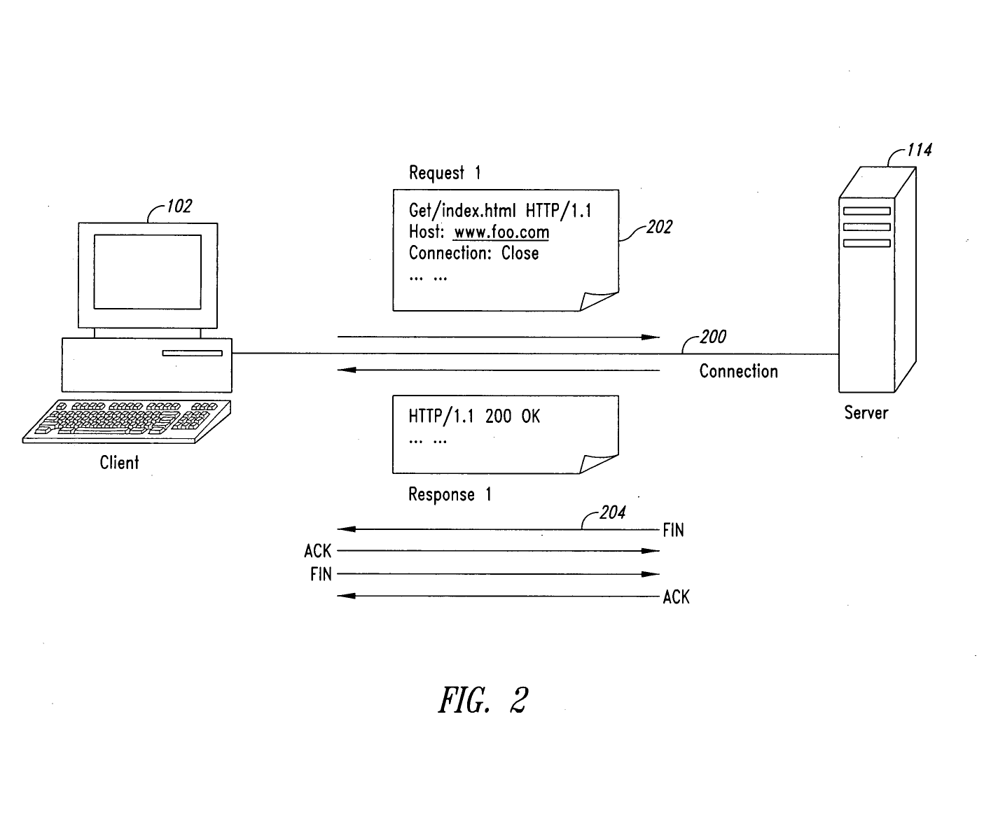

In addition to RESET/FIN triggered in the TCP layer, TCP connection termination can also be initiated in the HTTP layer, which will again cause RESET/FIN in the TCP layer to be issued. FIG. 2 illustrates this termination behavior. This termination is implied by a “Connection: Close” header in a HTTP 1.1 request/response message, or in a HTTP 1.0 request/response message that does not explicitly include a “Connection: Keep-Alive” header. In this case illustrated in FIG. 2, when the receiver (e.g., the server 114) receives such a message, the server 114 will initiate a FIN to close the connection after the transaction (a request+a response) is finished.

Specifically in the example of FIG. 2, a connection 200 has already been established. If there is a “Connection: Close” header included in a HTTP 1.1 request 202 from the client terminal 102, the header signals the server 114 that once the client terminal 102 successfully receives the response (which means that the server 114 has received the ACK packet to the response), the server 114 should terminate the connection 200. In this case, the server 114 gracefully terminates the connection 200 by initiating a FIN packet 204. In another situation, if a “Connection: Close” header is initially contained in the response from server 114, the client terminal 102 will initiate a FIN to close the connection 200 after the client terminal 102 receives the response, which means the transaction is finished.

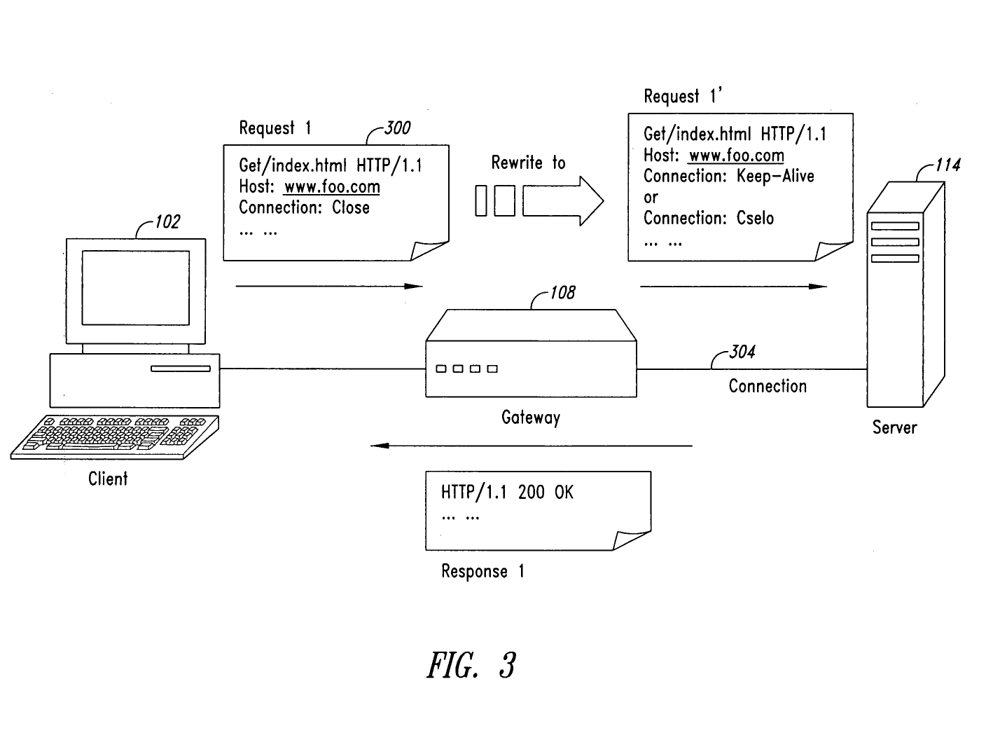

To address the situation depicted in FIG. 2, a third embodiment rewrites the “Connection: Close” header in the request sent by the client terminal 102. FIG. 3 is a flow diagram illustrating such a technique to maintain a persistent connection according to the third embodiment.

Since a persistent connection is not the default behavior of HTTP 1.0, if either the client terminal 102 or the server 114 only supports HTTP 1.0 and a request 300 from the client terminal 102 contains a “Connection: Close” header, the switch 108 (or some suitable gateway device) replaces this header with a “Connection: Keep-Alive” header, so that either one or both the client-side connection 302 and server-side connection 304 remains persistent. Thus, the example of FIG. 3 illustrates that when the switch 108 receives the request 300 (“Request 1”), the switch 108 rewrites its “Connection: Close” header to “Connection: Keep-Alive” so that the server 114 will not close the connection 304 after the transaction is completed.

This technique can thus be used for the following cases:
A client terminal sends a HTTP 1.1 request to a HTTP 1.0 server;
A client terminal sends a HTTP 1.0 request to a HTTP 1.1 server; or
A client terminal sends a HTTP 1.0 request to a HTTP 1.0 server.

Since the length of the new string in the header is generally going to be longer than the length of the old string in the former header, the total size of the segment or packet carrying this header may have to be increased, or the whole segment may have to be fragmented if the total size is more than maximum transmission unit (MTU) of the packet. The IP and TCP checksum of the packet may also need to be recalculated. A person skilled in the art having the benefit of this disclosure can implement a suitable technique for increasing the size of the segment (or packet), fragmenting the segment, recalculating the IP and TCP checksum, or other operations associated with accommodating the modified new size of the segment having the “Connection: Keep-Alive” header.

It is noted that according to a fourth embodiment, the request 300 sent from the client terminal 102 may not necessarily contain the “Connection: Close” header. In such a situation, the fourth embodiment inserts the “Connection: Keep-Alive” header to keep the connection 302 or 304 persistent. As with the third embodiment, this operation may also involve fragmentation or TCP/IP checksum recalculation.

It is also noted that according to the fourth embodiment, the application of the “Connection: Keep-Alive” header is not restricted to solely a GET request. The “Connection: Keep-Alive” header may be applied to any or all of the HTTP request methods, such as POST, PUT, HEAD, DELETE, OPTIONS, TRACE, CONNECT, and so forth.

In yet a fifth embodiment (still using FIG. 3 for reference), if the request 300 with the “Connection: Close” header is sent from the HTTP/1.1 client terminal 102 to the HTTP/1.1 server 114, either the header name or the header value of the “Connection: Close” header is erased or distorted, so that the server 114 will not be notified of the request to close and will thus still keep the connection persistent. More specifically, if the server 114 is unable to recognize the “Connection: Close” header, then the server 114 will not perform the corresponding action to close the connection.

There, this fifth embodiment provides a simpler approach in that to avoid checksum recalculation or fragmentation due to data modification, the “Connection: Close” header can be destroyed by exchanging two two-byte strings at the even boundary of packets. For example, “Connection: Close” may become “nnCoection: Close” by having the switch 108 destroy the header name, or the header may be modified to “Connection: Cselo” by destroying the header value. The server 114 will ignore this header since the server 114 cannot understand it, and a simpler approach is thus provided because the total length of the string remains unchanged.

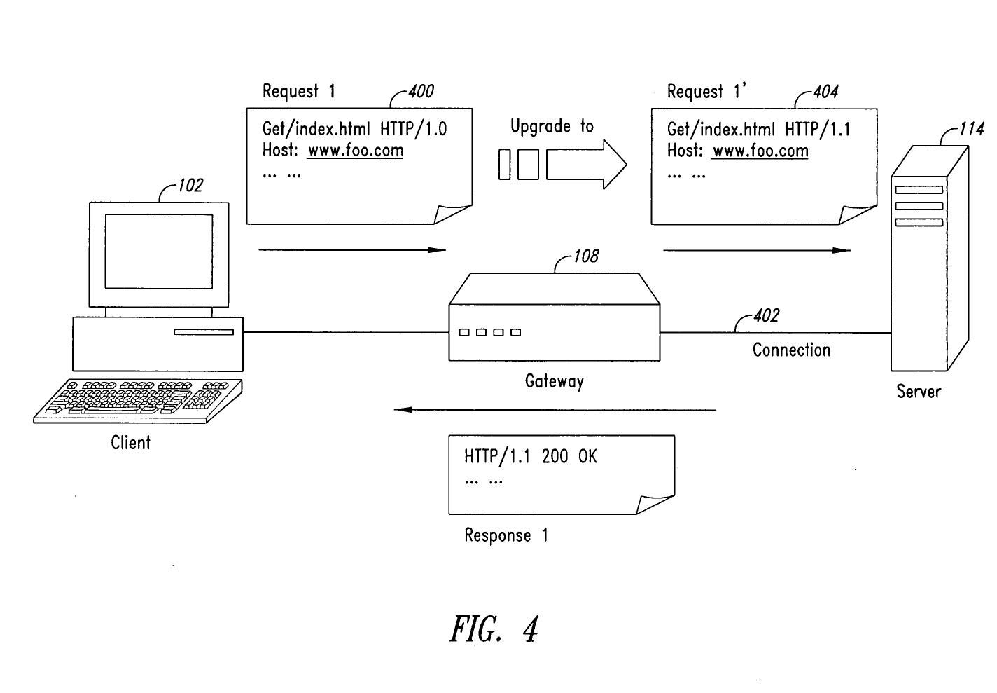

FIG. 4 is a flow diagram illustrating a sixth embodiment for maintaining a persistent connection. Since a persistent connection is the default behavior of HTTP 1.1 but not the default behavior of HTTP 1.0, if a request 400 without a “Connection: Close” header is sent from a HTTP 1.0 client 102 to a HTTP 1.1 server 114, the server 114 under standard circumstances is supposed to close the connection after the transaction is completed. To keep the server-side connection 402 persistent, an approach of the sixth embodiment is to upgrade the HTTP 1.0 request to a HTTP 1.1 request. This upgrade can be achieved by having the switch 108 modify the version value from 1.0 to 1.1 in the request 400 (resulting in the modified request 404) and adjusting the TCP checksum properly because of the difference, as necessary.

It is noted that if the server 114 sends a response with a “Connection: Close” header to the client terminal 102 over a persistent connection 402, again, the switch 108 of an embodiment will respect the server's 114 will and forward the response as-is to the client terminal 102 and close the connection 402.

In conclusion therefore, the above mechanisms provide a way to extend the keep-alive time of persistent connections so that more traffic can be transferred over the same connection. The extension of persistent connections can be achieved by either hiding the RESET or FIN from one side connection to the other between a client side and a server side connection, or by modifying the HTTP content of a non-persistent message to a persistent message.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

For example, if a request is sent to a Forward HTTP proxy, the “Connection” header will be in proxy format, which means that instead of “Connection: Close” and “Connection: Keep-Alive” being in server format, there will be “Proxy-Connection: Close” and “Proxy-Connection: Keep-Alive” respectively. Throughout this disclosure, therefore, the various described embodiments are intended to cover both proxy and non-proxy implementations. Thus, the terms “Connection: Close,” for example, can cover both “Connection: Close” and “Proxy-Connection: Close.”

Additionally, the various embodiments of techniques described herein are not necessarily limited to only situations where GET requests are involved. The techniques may be applied to situations where any or all of the HTTP request methods, such as POST, PUT, HEAD, DELETE, OPTIONS, TRACE, CONNECT, and so forth are involved.

Moreover, although embodiments have been designated in terms of first, second, third, fourth, . . . sixth embodiments, it is understood that these terms are not intended to limit the invention solely to six embodiments. These embodiments can be modified, added to, combined, or otherwise changed to provide yet further embodiments.

These and other modifications can be made in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method, comprising:
at a network device, providing a hypertext transfer protocol (HTTP) client-side connection and a HTTP server-side connection;
receiving at said network device via said client-side connection a communication that signals said server-side connection to close; and
maintaining persistent, by said network device, at least the server-side connection in response to said communication received via said client-side connection.

2. The method of claim 1, further comprising closing the client-side connection while the server-side connection is maintained persistent.

3. The method of claim 1 wherein maintaining persistent at least the server-side connection in response to said communication received via said client-side connection includes:
de-linking, by said network device, the server-side connection from the client-side connection in response to a RESET packet received by said network device via said client-side connection.

4. The method of claim 1 wherein maintaining persistent at least the server-side connection in response to said communication received via said client-side connection includes:
de-linking, by said network device, the server-side connection from the client-side connection in response to a FIN packet received by said network device via said client-side connection.

5. The method of claim 1, further comprising said network device closing both the client-side and server-side connections in response to a FIN packet received by said network device via said server-side connection.

6. The method of claim 1 wherein maintaining persistent at least the server-side connection in response to said communication received via said client-side connection includes:
identifying, by said network device, a Connection: Close header in the communication received via the client-side connection; and
replacing, by said network device, the Connection: Close header in the communication with a Connection: Keep-Alive header.

7. The method of claim 6, further comprising said network device performing at least one of increasing a total length of a packet having the Connection: Close header, fragmenting the packet having the Connection: Close header, and recalculating a checksum of the packet.

8. The method of claim 1 wherein maintaining persistent at least the server-side connection in response to said communication received via said client-side connection includes:
inserting, by said network device, a Connection: Keep-Alive header in the communication if the communication does not contain any header information indicative of whether to close the HTTP connection.

9. The method of claim 1 wherein maintaining persistent at least the server-side connection in response to said communication received via said client-side connection includes:
modifying, by said network device, a header in the communication, from a format that signals the server-side connection to close to a format that is unrecognizable by a server coupled to said server-side connection, to cause the server to ignore the modified header.

10. The method of claim 9 wherein modifying the header in the request to the form that is unrecognizable to the server includes at least one of modifying a name of the header and modifying a value of the header.

11. The method of claim 1 wherein maintaining persistent at least the server-side connection in response to said communication received via said client-side connection includes:
changing, by said network device, a HTTP version value indicated in the communication to another HTTP version value that is recognizable by a server, coupled to said server-side connection, as being associated with a persistent connection.

12. The method of claim 11, further comprising adjusting a checksum based on a difference between the HTTP version values.

13. The method of claim 1 wherein the communication includes a header having a proxy format.

14. A method, comprising:
establishing at a network device a client-side connection and a server-side connection;
reading, by said network device, content of a packet received via the client-side connection; and
extending, by said network device, persistency of the server-side connection if the read content of the packet signals said server-side connection to close.

15. The method of claim 14 wherein establishing the client-side and server-side connections include establishing these connections as part of a hypertext transfer protocol (HTTP) connection.

16. The method of claim 14 wherein extending, by said network device, the persistency of the server-side connection includes:
de-linking, by said network device, the server-side connection from the client-side connection, if the read content indicates that the packet is a RESET packet received via the client-side connection.

17. The method of claim 14 wherein extending, by said network device, the persistency of the server-side connection includes:
de-linking, by said network device, the server-side connection from the client-side connection, if the read content indicates that the packet is a FIN packet received via the client-side connection.

18. The method of claim 14 wherein extending, by said network device, the persistency of the server-side connection includes:
identifying, by said network device, header information of the packet received via the client-side connection that signals the server-side connection to close; and
replacing, by said network device, the identified header information with new header information that maintains the server-side connection persistent.

19. The method of claim 14 wherein extending, by said network device, the persistency of the server-side connection includes:
determining, by said network device, that header information of the packet received via the client-side connection does not include any information that signals the server-side connection to close; and
applying, by said network device, header information in the packet that maintains the server-side connection persistent.

20. The method of claim 14 wherein extending, by said network device, the persistency of the server-side connection includes:
modifying, by said network device, header information in the packet, received via the client-side connection from a format that signals said server-side connection to close to a format that is unrecognizable by a server that is to receive the packet via the server-side connection.

21. The method of claim 14 wherein extending, by said network device, the persistency of the server-side connection includes:
changing, by said network device, a protocol version value indicated in the packet received via the client-side connection to a different protocol version value that corresponds to maintaining a persistent connection.

22. An article of manufacture, comprising:
a storage medium having instructions stored thereon that are executable by a processor of a network device to:
provide at said network device a hypertext transfer protocol (HTTP) client-side connection and a HTTP server-side connection;
receive via said client-side connection a communication that signals said server-side connection to close; and
maintain persistent, by said network device, at least the server-side connection in response to said communication received via said client-side connection.

23. The article of manufacture of claim 22 wherein the instructions to maintain at least the server-side connection persistent include instructions executable by said processor to:
de-link, by said network device, the server-side connection from the client-side connection in response to a RESET packet received via the client-side connection.

24. The article of manufacture of claim 22 wherein the instructions to maintain at least the server-side connection persistent include instructions executable by said processor to:
change, by said network device, header information in the communication received via the client-side connection to new header information corresponding to a persistent connection.

25. The article of manufacture of claim 22 wherein the instructions to maintain at least the server-side connection persistent include instructions executable by said processor to:
modify, by said network device, header information in the communication that signals the server-side connection to close to a format unrecognizable by a server coupled to said server-side connection, to cause the server to ignore the modified header information.

26. The article of manufacture of claim 22 wherein the instructions to maintain at least the server-side connection persistent include instructions executable by said processor to:
modify, by said network device, a protocol version number indicated in the communication to a different protocol version number that corresponds to a persistent connection.

27. An apparatus, comprising:
a network device adapted to be communicatively coupled between a client terminal and a server, the network device having:
communication terminal means for establishing a client-side connection and a server-side connection; and
means for reading content of a packet received via the client-side connection, and for extending persistency of the server-side connection if the read content of the packet signals said server-side connection to close.

28. The apparatus of claim 27 wherein the means for extending the persistency of the server-side connection modifies header information in the packet to format unrecognizable to a server coupled to said server-side connection to receive said packet.

29. The apparatus of claim 27 wherein the means for extending the persistency of the server-side connection modifies header information in the packet to indicate a protocol version that corresponds to a persistent connection.

30. The apparatus of claim 27 wherein the means for extending the persistency of the server-side connection de-links the server-side connection from the client-side connection in response to RESET content in the packet received via the client side connection.

31. An apparatus, comprising:
a network device having:
first and second communication terminals, the first terminal being associated with a hypertext transfer protocol (HTTP) client-side connection and the second terminal being associated with a HTTP server-side connection;
a processor coupled to the first and second communication terminals, and
software executable by the processor to maintain persistent at least the server-side connection in response to a communication received via said client-side connection that signals said server-side connection to close.

32. The apparatus of claim 31 wherein the software executable by said processor of said network device to maintain the server-side connection persistent includes code to modify a format of header information in the communication received via the client-side connection from a format that signals said server-side connection to close to a format that is unrecognizable by a server coupled to said server-side connection, to cause the server to ignore the header information.

33. The apparatus of claim 31 wherein the software executable by said processor of said network device to maintain the server-side connection persistent includes code to modify a HTTP protocol version value indicated in the communication received via the client-side connection to a HTTP protocol version value that is associated with a persistent connection.

34. The apparatus of claim 31 wherein the software executable by said processor of said network device to maintain the server-side connection persistent includes code to de-link the server-side connection from the client-side connection in response to said communication, containing a RESET, received via said client-side connection.

35. The apparatus of claim 31 wherein the software executable by said processor of said network device to maintain the server-side connection persistent includes code to modify a Connection: Close header in the communication to Connection: Keep-Alive header.

36. The apparatus of claim 31 wherein the software is also executable by said processor of said network device to close the server-side connection in response to at least one of a RESET and FIN received via the server-side connection.

37-42. (canceled)

43. The method of claim 1 wherein said network device includes a switch.

44. The method of claim 11 wherein changing the HTTP version value to another HTTP version value includes changing, by said network device, from HTTP version 1.0 indicated in said request to HTTP version 1.1.

45. The method of claim 14 wherein said network device includes a switch.

46. The article of manufacture of claim 22 wherein said network device includes a switch.

47. The article of manufacture of claim 22 wherein the instructions to maintain at least the server-side connection persistent, in response to said communication received via said client-side connection, include instructions executable by said processor to:
de-link, by said network device, the server-side connection from the client-side connection in response to a FIN packet received via the client-side connection.

48. The apparatus of claim 27 wherein said network device includes a switch.

49. The apparatus of claim 27 wherein the means for extending the persistency of the server-side connection, if the read content of the packet signals said server-side connection to close, maintains persistency by de-linking the server-side connection from the client-side connection in response to FIN content in the packet received via the client side connection.

50. The apparatus of claim 27 wherein the means for extending the persistency of the server-side connection, if the read content of the packet signals said server-side connection to close, maintains persistency by de-linking the server-side connection from the client-side connection in response to RESET content in the packet received via the client side connection.

51. The apparatus of claim 27 wherein the means for extending the persistency of the server-side connection, if the read content of the packet signals said server-side connection to close, maintains persistency by replacing a Connection: Close header of the packet with a Connection: Keep-Alive header.

52. The apparatus of claim 31 wherein the software executable by said processor of said network device to maintain the server-side connection persistent, in response to said communication received via said client-side connection that signals said server-side connection to close, includes code to de-link the server-side connection from the client-side connection in response to said communication, containing a FIN, received via said client-side connection.
